(19) United States
(12) Patent Application Publication
(10) Pub. No.: US 2025/0138469 A1
(43) Pub. Date: May 1, 2025

(54) CLEANING DEVICE

(71) Applicant: CANON KABUSHIKI KAISHA, Tokyo (JP)

(72) Inventors: JUNICHI SEKIYAMA, Tokyo (JP); YUKI NISHIZAWA, Kanagawa (JP); TOMOAKI NAKAI, Shizuoka (JP)

(21) Appl. No.: 18/929,319

(22) Filed: Oct. 28, 2024

(30) Foreign Application Priority Data
Oct. 31, 2023 (JP) 2023-187027

(51) Int. Cl. G03G 21/00; G03G 15/16

(52) U.S. Cl. CPC G03G 21/0047; G03G 15/161; G03G 21/0035; G03G 21/0076

(57) ABSTRACT

A cleaning device includes a first rotating member including a first adsorption portion configured to electrostatically adsorb an object to be collected from a surface to be cleaned, a second rotating member including a second adsorption portion configured to electrostatically adsorb the object to be collected from the first adsorption portion, a removable unit for removing the object to be collected adsorbed to the second adsorption portion, a housing container for housing the object to be collected, and a sealing member disposed between an end of the second adsorption portion in a longitudinal direction along a rotational axis of the second rotating member and the housing container. The cleaning device includes a regulating member for regulating a position of an end surface of the first adsorption portion to be inside of a contact region between the sealing member and the second adsorption portion in the longitudinal direction.

### BACKGROUND

### Field

The present disclosure relates to a cleaning device for collecting an object to be collected.

### Description of the Related Art

Conventionally, as a system for collecting an object to be collected, an electrostatic cleaning system has been known (Japanese Patent Application Publication No. 2015-84993). First, an object to be collected on a surface to be cleaned is electrostatically adsorbed to a first adsorption rotating member, and then the object to be collected is adsorbed and transferred from the first adsorption rotating member to a second adsorption rotating member adjacent to the first adsorption rotating member by a more powerful electrostatic force. After that, a removal member such as a blade is used to scrape off and collect the object to be collected from the second adsorption rotating member to a housing portion for the object to be collected.

Here, a sealing member is provided between the second adsorption rotating member and a housing portion for an object to be collected in order to prevent the object to be collected from leaking from the housing portion. In particular, sealing members on both ends in a longitudinal direction along a rotational axis direction of the second adsorption rotating member may cause sealing failure because a large amount of objects to be collected are taken on an upstream end of the sealing member in the rotating direction of the second adsorption rotating member. As a measure for preventing the risk, there is a method for disposing the sealing member with a clearance such that the sealing member is on the outer side with a predetermined distance from the maximum cleaning width of the first adsorption rotating member in the longitudinal direction (Japanese Patent Application Publication No. 2016-62065).

### SUMMARY

However, the position of an end of the first adsorption rotating member in the longitudinal direction may vary to the outer side in the longitudinal direction at a contact portion with the second adsorption rotating member. Thus, in consideration of the varying, the sealing member needs to be disposed with a clearance on the outer side by a predetermined distance, which leads to a problem in that the size in the product width direction increases. In particular, as a countermeasure for unevenness of a surface to be cleaned, if a brush having a long hair is used as the first adsorption rotating member, an end of the brush varies between the brush and the second adsorption rotating member, and hence the positions of longitudinal ends of the first adsorption rotating member further vary, with the result that a larger clearance needs to be set. In a case where such a cleaning device is applied to a collection portion for paper dust or toner in an electrophotographic image forming apparatus, the size of the cleaning device may hinder the downsizing of the image forming apparatus.

The present disclosure provides a technology capable of downsizing a cleaning device.

As such, a cleaning device of the present disclosure includes a first rotating member including a first adsorption portion configured to electrostatically adsorb an object to be collected from a surface to be cleaned; a second rotating member including a second adsorption portion configured to electrostatically adsorb the object to be collected from the first adsorption portion; a removable unit configured to remove the object to be collected that has been adsorbed to the second adsorption portion; a housing container configured to house the object to be collected that has been removed by the removable unit; a sealing member disposed between an end portion of the second adsorption portion in a longitudinal direction along a rotational axis of the second rotating member and the housing container, and a regulating member configured to regulate a position of an end surface of the first adsorption portion to be inside of a contact region between the sealing member and the second adsorption portion in the longitudinal direction.

According to the present disclosure, a cleaning device can be downsized.

Further features of the present disclosure will become apparent from the following description of exemplary embodiments with reference to the attached drawings.

### BRIEF DESCRIPTION OF THE DRAWINGS

FIG. 1 is a cross-sectional view illustrating a schematic configuration of a cleaning device according to Example 1;

FIG. 2 is a perspective view illustrating a schematic configuration of the cleaning device according to Example 1;

FIG. 3 is a perspective view illustrating exploded schematic configurations of the cleaning device according to Example 1;

FIG. 4 is a schematic perspective view for describing a sealing configuration in Example 1;

FIGS. 5A to 5C are explanatory views of a positional relation between an edge sealing and a regulating member in Example 1;

FIGS. 6A and 6B are explanatory views of a positional relation between an edge sealing and a regulating member in Example 2;

FIG. 7 is a perspective view of the vicinity of a regulating guide in Example 2;

FIGS. 8A and 8B are explanatory views of a positional relation between an edge sealing and a regulating member in Example 3;

FIG. 9 is a perspective view of the vicinity of a regulating guide in Example 3;

FIGS. 10A and 10B are schematic perspective views of a cleaning device according to Example 4; and

FIG. 11 is a transverse cross-sectional view of an image forming apparatus including a cleaning device according to the present example.

### DESCRIPTION OF THE EMBODIMENTS

In the following examples, embodiments in the present disclosure are exemplarily described. However, the configurations disclosed in the following examples, such as the functions, materials, shapes, and relative arrangements of components, are illustrative of forms related to the scope of claims, and are not intended to limit the scope of claims to the configurations disclosed in the examples. Furthermore, problems to be solved by the configurations disclosed in the following examples or functions and effects obtained by the disclosed configurations are not intended to limit the scope of claims.

### Example 1

### Overall Configuration

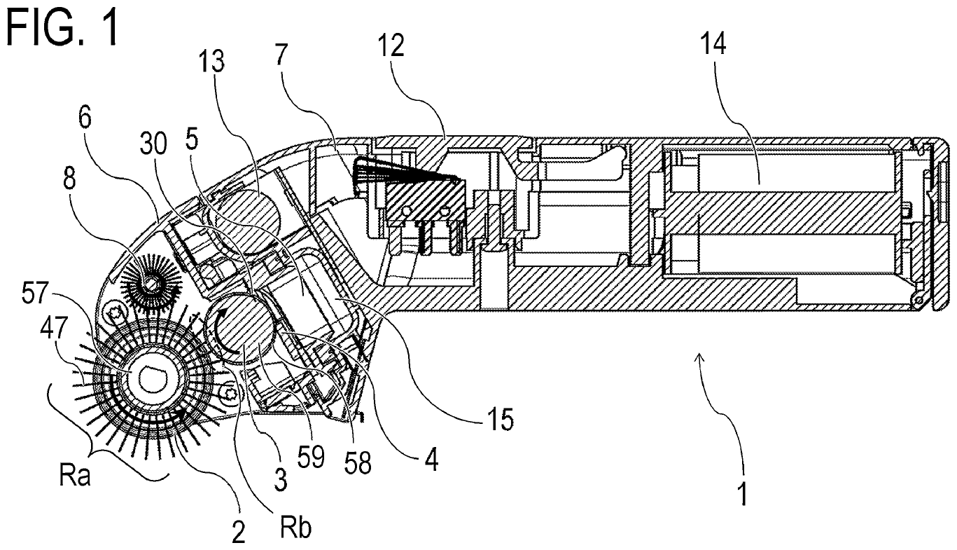

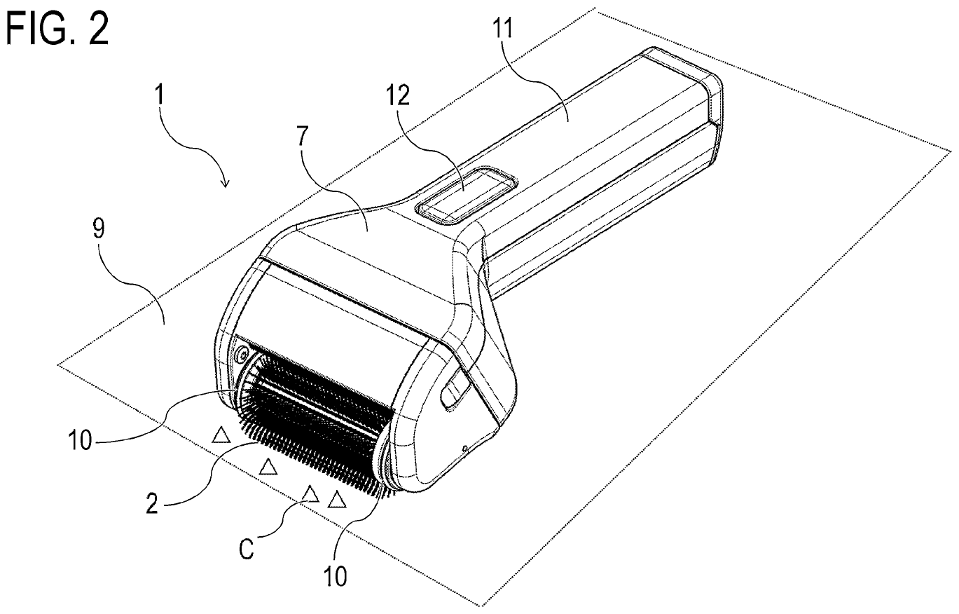

Referring to FIGS. 1 to 4, an overall configuration of a cleaning device in Example 1 of the present disclosure is described. FIG. 1 is a cross-sectional view illustrating a schematic configuration of an electrostatic cleaning device 1 according to Example 1 of the present disclosure. FIG. 2 is a perspective view illustrating the appearance of the cleaning device 1 according to the present example.

As illustrated in FIG. 1, a device housing of the cleaning device 1 is configured by an A frame body 6, as a first frame body, and a B frame body 7 as a second frame body. The A frame body 6 is provided with a first adsorption rotating member 2, a second adsorption rotating member 3, a blade 4, a dust container 5, and a rubbing member 8. The B frame body 7 is provided with a power supply switch 12, a drive motor 13, a battery 14, and a dust container lid 15. Furthermore, as illustrated in FIG. 2, the A frame body 6 is provided with a pair of wheels 10 at both ends, in a longitudinal direction along a rotational axis direction of the first adsorption rotating member 2, and exposed from an opening of the A frame body 6. Furthermore, on the exterior of the B frame body 7, a handle 11, used by a user to hold the cleaning device 1, is provided, and the power supply switch 12 is exposed.

In the cleaning device 1, as illustrated in FIG. 1, when a user presses the power supply switch 12 and the drive motor 13 starts driving, the first adsorption rotating member 2 rotates in the CCW direction, the second adsorption rotating member 3 rotates in the CW direction, and the rubbing member 8 rotates in the CCW direction due to the driving force transmitted from the drive motor 13. In the cleaning device 1, as illustrated in FIG. 2, in a state in which the user grips a handle 11 of the B frame body 7 of the cleaning device 1 and brings the first adsorption rotating member 2 into contact with a cleaning surface 9 that is a surface to be cleaned, the user moves the cleaning device 1 on the cleaning surface 9. Typically, the user moves the cleaning device 1 on the cleaning surface 9 forward in parallel to the cleaning surface 9, with the first adsorption rotating member 2 at the front. In this manner, an object to be collected (collection target) C (illustrated by A) such as dust on the cleaning surface 9 can be adsorbed to the first adsorption rotating member 2 by electrostatic force and captured and collected.

The first adsorption rotating member 2 has a brush 47 that forms a first adsorption portion capable of electrostatically adsorbing an object to be collected C from the cleaning surface 9, and a first rotation shaft 57 that is a first rotating member for supporting the brush 47. The second adsorption rotating member 3 is disposed side by side in parallel to the first adsorption rotating member 2. The second adsorption rotating member 3 has a second adsorption portion 58 capable of electrostatically adsorbing an object to be collected C from the brush 47, and a second rotation shaft 59 that is a second rotating member on which the cylindrical second adsorption portion 58 is provided on its outer periphery. The brush 47 has an adsorption region Ra to be opposed to the cleaning surface 9 and a collected region Rb opposed to the second adsorption portion 58. Along with the rotation of the first rotation shaft 57, an object to be collected C that has been adsorbed in the adsorption region Ra of the brush 47 moves to the collected region Rb due to the rotational movement of the brush 47 around a rotational axis of the first rotation shaft 57, and are adsorbed to the second adsorption portion 58.

The blade 4 as a removable unit is a blade member for removing an object to be collected C that has been adsorbed to the second adsorption portion 58 from the second adsorption portion 58. The blade 4 is attached to the A frame body 6 such that a direction from a fixed end of the blade 4 fixed to the A frame body 6 toward its distal end (free end) is substantially opposite to the rotating direction of the second adsorption portion 58 at a contact portion with the second adsorption portion 58. The dust container 5 and the dust container lid 15 configure a housing portion (housing container) for housing therein an object to be collected C removed from the second adsorption portion 58 by the blade 4.

In the present example, the brush 47 that is the first adsorption portion of the first adsorption rotating member 2 is formed from polyethylene (PET), and the second adsorption portion 58 of the second adsorption rotating member 3 is formed from fluorocarbon resin (PFA). Furthermore, a brush of the rubbing member 8 is formed from nylon, and the blade 4 is formed from urethane rubber. As a result, an object to be collected C that has been electrostatically adsorbed to the brush 47 of the first adsorption rotating member 2 is adsorbed and transferred toward the second adsorption portion 58 by a more powerful adsorption force of the second adsorption portion 58 of the second adsorption rotating member 3 in terms of triboelectric series at a proximity portion (collected region Rb) between the brush 47 and the second adsorption portion 58. The object to be collected C adsorbed to the second adsorption portion 58 is then scraped off from the second adsorption portion 58 by the blade 4, and collected in the housing unit configured by the dust container 5 and the dust container lid 15. The rubbing member 8 is used to stabilize the electrostatic adsorption force of the first adsorption rotating member 2 in a manner that the brush of the rubbing member 8 rubs with the brush 47 of the first adsorption rotating member 2. When the blade 4 rubs with the second adsorption portion 58 of the second adsorption rotating member 3, the blade 4 charges the second adsorption rotating member 3 to negative polarity more intensely. Details of electrostatic collection are separately described later.

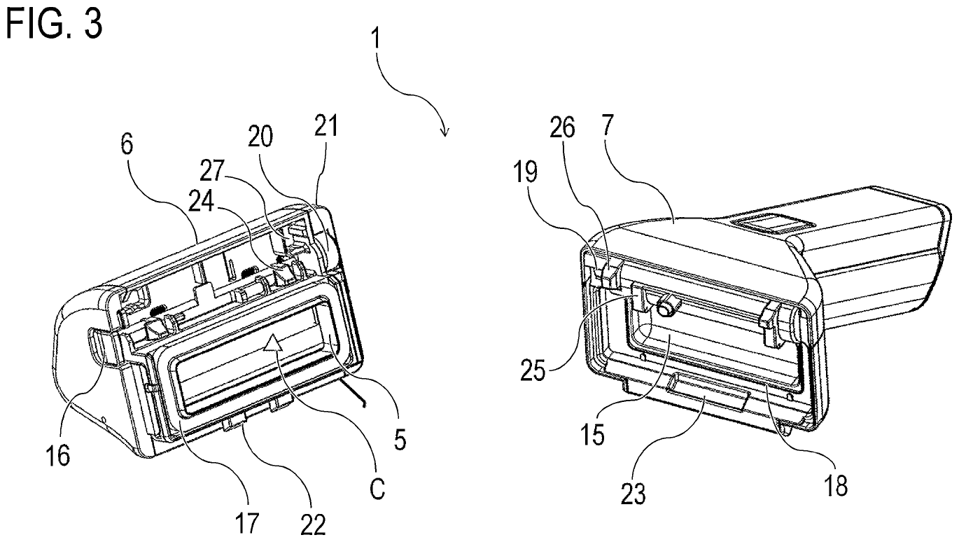

FIG. 3 is an exploded perspective view of the cleaning device. By pressing a latch button 16, as illustrated in FIG. 3, the cleaning device 1 can be divided into the A frame body 6 and the B frame body 7. Then, the dust container 5 and the dust container lid 15 are opened, and an object to be collected C can be taken out of the cleaning device 1. Furthermore, a packing 17 is disposed between the dust container 5 and the dust container lid 15, and when the dust container 5 and the dust container lid 15 are closed, a rib 18 digs into the packing 17 to prevent the object to be collected C from leaking. Furthermore, in the closed state, an output gear 19 connected to the drive motor 13 (not shown in FIG. 3) and an input gear 20 engage with each other, and hence driving is transmitted to each rotating member through a drive transmission mechanism (not shown) in the case 21. Note that the A frame body 6 and the B frame body 7 are fixed in a manner that protrusions 22 are engaged with a groove 23 and then the A frame body 6 and the B frame body 7 are relatively rotated around the engaged portion such that a D hook 24 of the latch button 16 is engaged with an E hook 25. Note that a boss 26 and a hole 27 are positioning engagement portions.

### Sealing Configuration

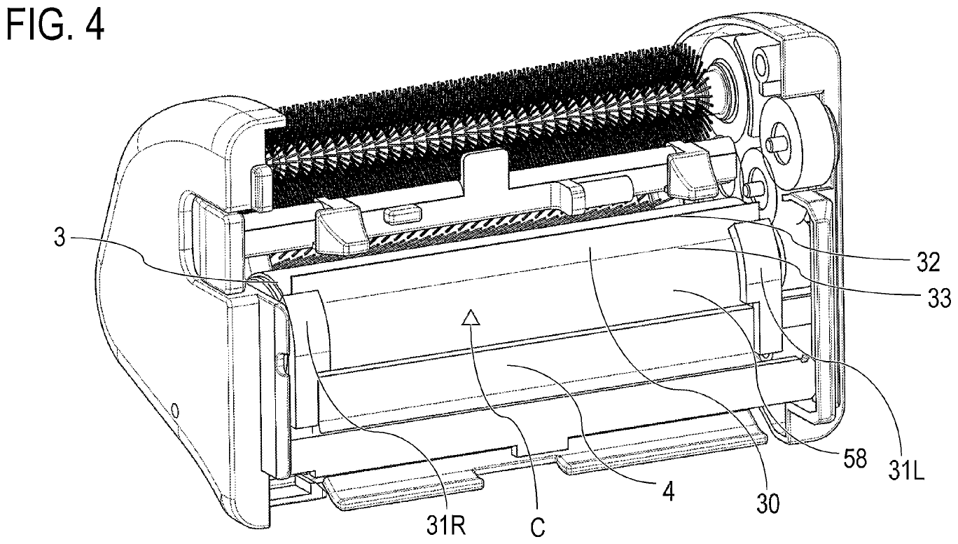

Referring to FIG. 4, a configuration for preventing leakage of an object to be collected by a sealing configuration between the second adsorption rotating member 3 and the dust container 5 is described. FIG. 4 is a schematic perspective view of a partial part of a sealing configuration in the vicinity of the second adsorption rotating member 3. A sealing member for forming such a sealing configuration in the present example includes the blade 4, a scooping sheet 30, a first sealing member 31R and a second sealing member 31L (edge sealing), and the blade 4, the scooping sheet 30, the first sealing member 31R and the second sealing member 31L each slidably contact with the second adsorption portion 58 of the second adsorption rotating member 3. In the second adsorption portion 58, a region surrounded by the above-mentioned sealing member is a second collected region that is exposed to the inside of the dust container 5, and in this region, an object to be collected C that has been adsorbed from the brush 47 as the first adsorption portion is removed.

A pair of the first sealing member 31R and the second sealing member 31L are disposed correspondingly to both ends of the second adsorption portion 58 in the longitudinal direction along a rotational axis direction of the second adsorption rotating member 3. The first sealing member 31R is disposed between one end of the second adsorption portion 58 in the longitudinal direction and the dust container 5, and the second sealing member 31L is disposed between the other end of the second adsorption portion 58 in the longitudinal direction and the dust container 5.

The blade 4 forms a contact region with the second adsorption portion 58, which extends in the longitudinal direction between an end of the first sealing member 31R on the downstream side in the rotating direction of the second adsorption rotating member 3 and an end of the second sealing member 31L on the downstream side in the rotating direction of the second adsorption rotating member 3. The scooping sheet 30 is provided so as to contact with the second adsorption portion 58 on the side opposite to the side where the blade 4 is disposed in the above-mentioned collected region of the second adsorption portion 58 in the rotating direction of the second adsorption rotating member 3. The scooping sheet 30 forms a contact region with the second adsorption portion 58, which extends in the longitudinal direction between an end of the first sealing member 31R on the upstream side in the rotating direction of the second adsorption rotating member 3 and an end of the second sealing member 31L on the upstream side in the rotating direction of the second adsorption rotating member 3.

Furthermore, a surface of each sealing member described above on the front side in the drawing adheres to the dust container 5 (not shown in FIG. 4). In this manner, the second collected region surrounded by the first sealing member 31R, the second sealing member 31L, the blade 4, and the scooping sheet 30 is exposed to the inside of the housing portion formed by the dust container 5 and the dust container lid 15. Each sealing member prevents an object to be collected from leaking from a gap between the second adsorption rotating member 3 and the dust container 5.

Note that, in the present example, urethane rubber is used for the blade 4, and highly slidable fiber piles are used for the first sealing member 31R and the second sealing member 31L. Furthermore, the scooping sheet 30 is a sheet member using an ultrathin PET sheet. The scooping sheet 30 on the edge 32 side adheres to the dust container 5 (not shown in FIG. 4), and the scooping sheet 30 on the opposite edge 33 side freely contacts the second adsorption rotating member 3 with a significantly small contact pressure. A direction from the edge 32 as a fixed end toward the edge 33 as a free end is substantially the same (substantially forward direction) as the rotating direction of the second adsorption portion 58 at a contact portion with the second adsorption portion 58. Thus, an object to be collected C that has been adsorbed to the second adsorption rotating member 3 passes by the edge 33 and collected to the dust container 5. On the other hand, the collected object to be collected C hardly leaks out from the edge 33 owing to its check valve configuration.

### Details of Electrostatic Collection

Referring to FIG. 1 again, electrostatic collection is specifically described.

In general, an object to be collected on the cleaning surface 9 (not shown in FIG. 1) is paper dust, wool, or other materials on the positive side in the triboelectric series in many cases. In the triboelectric series, the first adsorption rotating member 2 (brush 47) is made of a material on the negative side, and the rubbing member 8 is made of a material on the positive side. Thus, when the rubbing member 8 and the first adsorption rotating member 2 rub with each other, the first adsorption rotating member 2 is charged to negative polarity. As a result, when the first adsorption rotating member 2 faces the cleaning surface 9, an object to be collected on the cleaning surface 9 that is charged to positive polarity can be electrostatically adsorbed in a non-contact manner.

Furthermore, when the first adsorption rotating member 2 rubs the cleaning surface 9 or an object to be collected on the cleaning surface 9 along with the movement of the cleaning device 1, the object to be collected is charged to be positive. Thus, the first adsorption rotating member 2 that has been negatively charged due to the rubbing with the rubbing member 8 and the object to be collected have opposite charging polarities, and hence the object to be collected on the cleaning surface 9 can be electrostatically adsorbed efficiently.

Furthermore, the second adsorption rotating member 3 is made of a material on the more negative side than the first adsorption rotating member 2 and the blade 4 in the triboelectric series. Thus, when the second adsorption rotating member 3 rubs with the first adsorption rotating member 2 or the blade 4, the second adsorption rotating member 3 is charged to negative polarity more powerfully, and hence an object to be collected that has been adsorbed by the first adsorption rotating member 2 can be adsorbed and transferred to the second adsorption rotating member 3.

Note that, in the case of collecting an object to be collected that is on the negative side in the triboelectric series, the object to be collected can be collected in a manner that, in the triboelectric series, the first adsorption rotating member 2 is on the more positive side than the object to be collected and the second adsorption rotating member 3 is made of a material on the more positive side than the first adsorption rotating member 2 and the blade 4.

### Positional Relation between Edge Sealing and Regulating Member

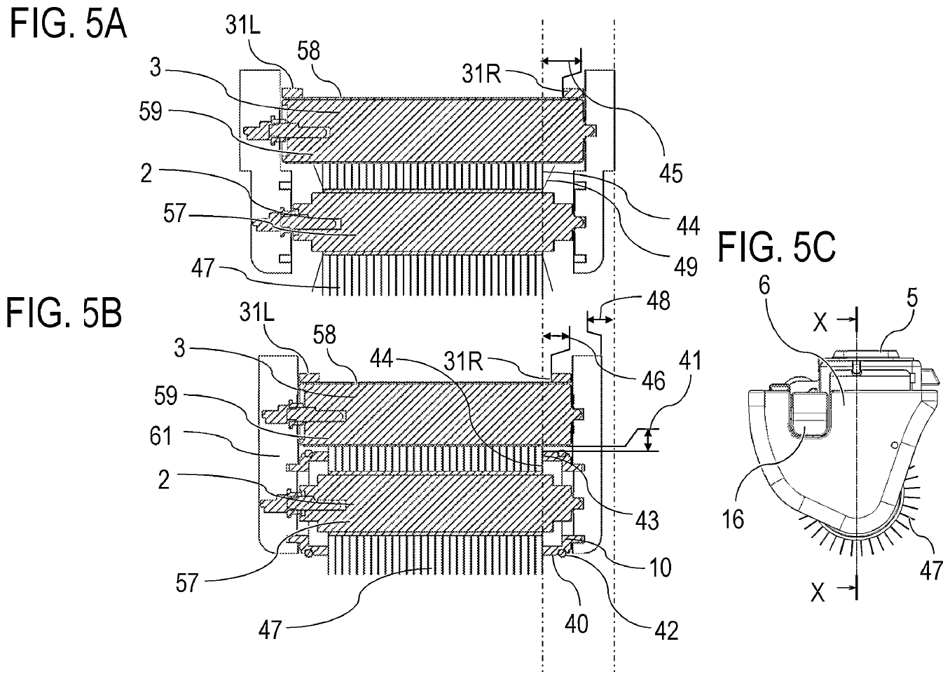

Referring to FIGS. 5A to 5C, a positional relation between the first sealing member 31R, the second sealing member 31L and longitudinal ends of the first adsorption rotating member 2 is described. Here, an example in which an appropriate regulating member is disposed at an end of the first adsorption rotating member 2 in the present example such that the end of the first adsorption rotating member 2 is stably regulated from varying to the outer side in the longitudinal width direction is described.

The cleaning device 1 according to the present example includes a wheel 10 as a configuration for regulating a maximum penetration level of the first adsorption rotating member 2 (brush 47) into the cleaning surface 9. In the present example, the wheel 10 as a disc member is configured to function as a regulating member for regulating the position of an end surface of the brush 47 as the first adsorption portion in the longitudinal direction to be located on the inner side than contact regions between the first sealing member 31R, the second sealing member 31L and the second adsorption portion 58.

FIG. 5A is a schematic simple view in a top surface direction for describing a positional relation between the first sealing member 31R, the second sealing member 31L and a longitudinal end surface 44 of the brush 47 of the first adsorption rotating member 2 in a comparative example. FIG. 5B is a schematic view in a top surface direction for describing a positional relation between the first sealing member 31R, the second sealing member 31L and a longitudinal end surface 44 of the first adsorption rotating member 2 in Example 1, which is a view obtained by simplifying the cross section of the A frame body 6 taken along the line X-X illustrated in FIG. 5C. FIG. 5C is a view for describing a cross-sectional part illustrating the positional relation between the first sealing member 31R, the second sealing member 31L and the regulating member in Example 1.

The wheel 10 is a pair of disc members on both sides of the first adsorption rotating member 2 in the longitudinal direction, which are pivotally supported to a frame 61 of the A frame body 6 rotatably (freely rotatably) so as to be rotatable about a rotational axis that is substantially coaxially with the rotational axis of the first adsorption rotating member 2. The wheel 10 is disposed in proximity to the second adsorption rotating member 3 such that a distance 41 between an outer circumferential surface 40 of the wheel 10 and the surface of the second adsorption rotating member 3 is about 1 mm or less.

When the wheel 10 is used in contact with the cleaning surface 9 (not shown in FIGS. 5A to 5C), the wheel 10 is driven to rotate in accordance with the movement of the cleaning device 1. In other words, the wheel 10 contacts the cleaning surface 9 so as to maintain a constant opposing distance between the first adsorption rotating member 2 (brush 47) and the cleaning surface 9 and rotates along with the movement of the cleaning device 1 by a user, thereby guiding the movement of the cleaning device 1 along the cleaning surface 9. An elastic member 42 is wound around the wheel 10 so as not to damage the cleaning surface 9.

A side surface 43 of the wheel 10 configures a circular regulating surface (contact portion) for regulating an end surface 44 of the brush 47 (brush hair at longitudinal end among brush hairs constituting brush 47) of the first adsorption rotating member 2 from varying to the outer side in the longitudinal direction.

In this case, as illustrated in FIG. 5A, when contacting the cleaning surface 9 or the second adsorption portion 58, the brush 47 may become a state in which a brush hair 49 at an end in the longitudinal direction among a plurality of brush hairs is inclined (varied) to the outer side in the longitudinal direction. In the comparative example illustrated in FIG. 5A, a clearance between the first sealing member 31R and the brush 47 in the longitudinal direction needs to be set in consideration of the varying of the brush 47 such as brush hair 49. In other words, a clearance 45 that is a longitudinal distance between a contact region of the first sealing member 31R and the second adsorption portion 58 and the longitudinal end surface 44 of the brush 47 needs to be secured even when the brush hair 49 varies.

On the other hand, as illustrated in FIG. 5B, in the present example, the occurrence of the varying of the brush hair 49 in the comparative example illustrated in FIG. 5A is suppressed by the wheel 10 as a regulating member. The wheel 10 regulates the position of the longitudinal end surface 44 of the brush 47 in the collected region Rb to the inner side of contact regions between the first sealing member 31R, the second sealing member 31L and a longitudinal end of the second adsorption portion 58 in the longitudinal direction. In this case, when a gap between the first sealing member 31R and the end surface 44 of the brush 47 in the longitudinal direction is referred to as a clearance 46, the clearance 46 can be set to be narrower than the clearance 45 in the comparative example illustrated in FIG. 5A. In other words, the varying of the brush hair of the brush 47 to the outer side in the longitudinal direction can be suppressed by the wheel 10, and hence the clearance 46 can be minimized as compared to the clearance 45 illustrated in FIG. 5A in the case where there is no regulating surface on the end surface 44. As a result, the risk of the occurrence of a brush hair 49 that varies to the outer side in the brush 47 as illustrated in FIG. 5A can be eliminated, and hence as compared with the configuration in the comparative example in FIG. 5A, the product size can be reduced in the longitudinal direction by the distance 48 illustrated in FIG. 5B.

Note that, by decreasing the distance 41 as much as possible such that the wheel 10 is brought into close contact with the second adsorption rotating member 3, the wheel 10 can be brought into contact to the brush distal end side of the brush 47 of the first adsorption rotating member 2, thereby more stably suppressing the occurrence of varying of the brush 476. The side surface 43 of the wheel 10 is a side surface having a rib shape on its outer circumference, which is provided in proximity to the outer circumferential surface 40 of the wheel 10. Then, the wheel 10 contacts the cleaning surface 9 (not shown in FIGS. 5A to 5C), and hence the more distal end part of the end surface 44 of the brush 47 of the first adsorption rotating member 2 can be regulated. Then, the side surface 43 of the wheel 10 is connected from the position of the cleaning surface 9 (adsorption region Ra in FIG. 1) to the position to transfer an object to be collected to the second adsorption rotating member 3 (collected region Rb in FIG. 1) with a smooth surface. Thus, the varying of the brush 47 can be smoothly guided.

Note that, in the present example, the side surface 43 of the wheel 10 is a regulating surface on the assumption of the configuration in which the wheel 10 is disposed, but another member having a similar shape may be disposed at the same position such that a regulating surface independent from the wheel 10 is formed.

Furthermore, in the drawings in the present example, the first adsorption portion of the first adsorption rotating member 2 has a brush shape, but the configuration of the first adsorption portion is not particularly limited to a brush, and may be an elastic member such as sponge or a rigid body. An embodiment in which the first adsorption portion is a rigid body is described later as Example 4.

In the present example, the outer diameter of the wheel 10 is set such that the brush 47 of the first adsorption rotating member 2 digs into the cleaning surface 9 by 5 mm. Furthermore, the dig amount of the brush 47 into the second adsorption rotating member 3 is 4 mm, and hence an object to be collected can be adsorbed and transferred more stably. The second sealing member 31L on the other end (left side in the drawing) is configured similarly, and detailed descriptions thereof are omitted.

According to the present example, the clearances between the first sealing member 31R, the second sealing member 31L and the first adsorption portion of the first adsorption rotating member 2 in the longitudinal direction can be minimized to downsize the product width. This means that when compared with a configuration in which the longitudinal width of the apparatus is equal, the longitudinal width of a cleaning region can be further increased.

Furthermore, according to the present example, the clearance between the edge sealing and an end of the first adsorption rotating member in the longitudinal direction can be appropriately decreased to reduce the size of the product width, thereby reducing manufacturing cost. Furthermore, in a case where the cleaning device in the present example is loaded in another device as a cleaning unit, the device size can be reduced, and furthermore, when the cleaning device needs to be detached from the device, the detachability can be improved due to the downsizing of the cleaning unit. Furthermore, the cleaning width can be increased as much as possible while reducing the product width, and hence a corner of a wall on a cleaning surface can be cleaned.

### Example 2

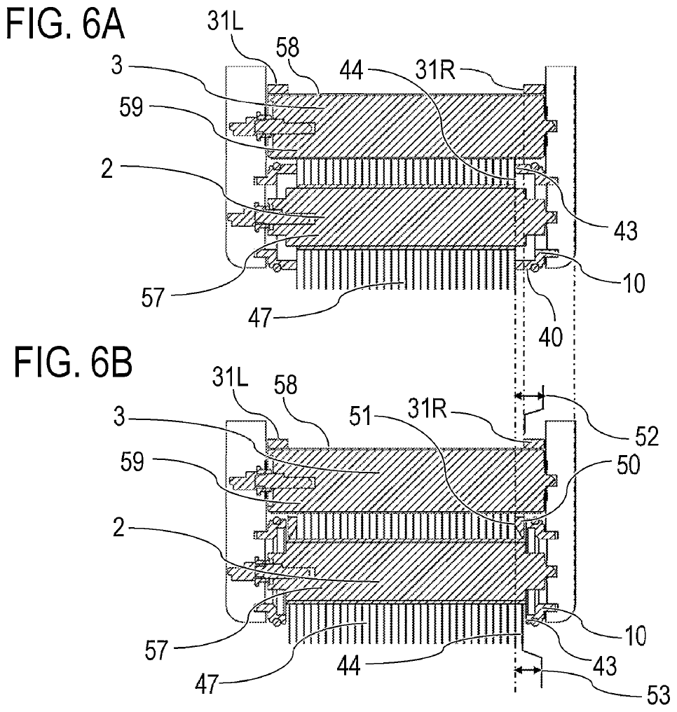

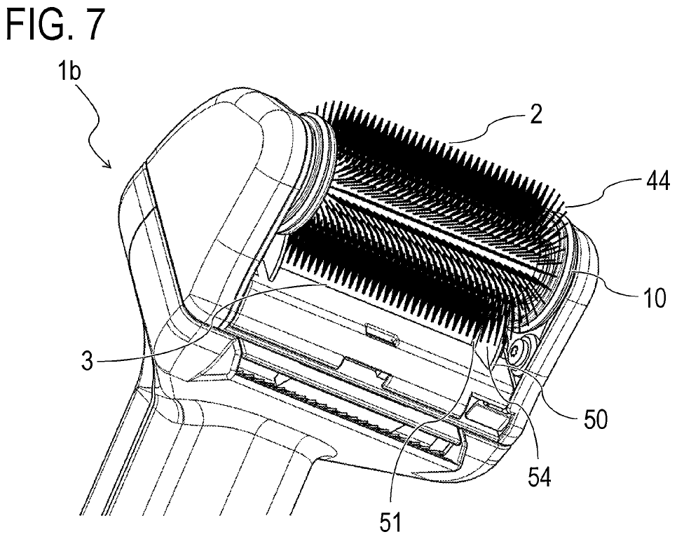

Referring to FIGS. 6A and 6B and FIG. 7, a cleaning device 1b according to Example 2 of the present disclosure is described. Configurations in Example 2 different from Example 1 are mainly described. Configurations in Example 2 common to Example 1 are denoted by the same reference symbols, and repetitive descriptions are omitted. Matters that are not particularly described in Example 2 are the same as in Example 1.

The cleaning device 1b according to Example 2 is different from Example 1 in that the first adsorption rotating member 2 is configured such that the longitudinal width thereof can be maintained large in a region contacting the cleaning surface 9 (adsorption region Ra) while the longitudinal width thereof can be decreased in a transfer portion region for the second adsorption rotating member 3 (collected region Rb). In other words, the cleaning device 1b according to Example 2 can downsize the unit in the width direction and maximize the cleaning width.

FIG. 6A is a view for a comparative configuration in Example 2, which is similar to FIG. 5B in Example 1. FIG. 6B is a schematic simple view in a top surface direction for describing a positional relation between the first sealing member 31R, the second sealing member 31L and a longitudinal end surface 44 of the brush 47 of the first adsorption rotating member 2 in Example 2.

In the cleaning device 1b according to the present example, a regulating guide 50 is disposed between the end surface 44 of the first adsorption rotating member 2 and the wheel 10. The regulating guide 50 has a side surface 51, which is a contact portion provided to the A frame body 6 so as to contact the end surface 44 of the brush 47 in the longitudinal direction and which is a contact surface (regulating surface) oriented inward in the longitudinal direction. The regulating guide 50 contacts the end surface 44 of the brush 47 such that an end surface 44 of a brush hair in at least the collected region Rb (see FIG. 1) among end surfaces 44 of the brush 47 is located on the inner side of contact regions between the first sealing member 31R, the second sealing member 31L and the second adsorption portion 58 in the longitudinal direction. On the other hand, the regulating guide 50 is configured not to contact an end surface 44 of a brush hair in the adsorption region Ra (see FIG. 1) opposed to the cleaning surface 9 among end surfaces 44 of the brush 47. In other words, the regulating guide 50 is provided, in a circumferential direction around the rotational axis of the first rotation shaft 57, at a position that is shifted from a position corresponding to the adsorption region Ra but corresponds to the collected region Rb of the brush 47.

Furthermore, a side surface 51 of the regulating guide 50 is located on the inner side of an end surface 44 of a brush hair in the adsorption region Ra among end surfaces 44 of the brush 47 in the longitudinal direction. In other words, when viewed in the circumferential direction around the rotational axis of the first rotation shaft 57, the regulating guide 50 overlaps the vicinity of an end of the brush 47 including the end surface 44 of the brush hair in the adsorption region Ra among brush hairs of the brush 47. Thus, the longitudinal position of the end surface 44 of the brush hair in the adsorption region Ra among brush hairs of the brush 47 is located on the outer side of the longitudinal position of the end surface 44 of the brush hair in the collected region Rb among brush hairs of the brush 47.

The longitudinal width of the brush 47 of the first adsorption rotating member 2 in the present example (FIG. 6B) is larger than the longitudinal width of the brush 47 of the first adsorption rotating member 2 in Example 1 (FIG. 6A) by a distance 53. Furthermore, the width of the wheel 10 in the present example (FIG. 6B) is smaller than the width of the wheel 10 in Example 1 (FIG. 6A).

Note that, in the present example, the side surface 43 of the wheel 10 is located with a predetermined clearance in the longitudinal direction from the end surface 44 of the brush 47 that is not in contact with the cleaning surface 9. By adjusting the longitudinal position of the side surface 43 of the wheel 10, the side surface 43 can function as a second regulating member for regulating a longitudinal range of a cleaning region of the brush 47 for the cleaning surface 9 to a predetermined range when the brush 47 varies due to contact with the cleaning surface 9.

The side surface 51 of the regulating guide 50 pushes the end surface 44 of the brush 47 of the first adsorption rotating member 2 to a predetermined position in the longitudinal direction so that, when a longitudinal clearance between the first sealing member 31R and the side surface 51 is denoted by 52, the clearance 52 is suppressed to the same level of the clearance in Example 1. Furthermore, the regulating guide 50 regulates only the end surface 44 in the vicinity of a transfer area (collected region Rb) for an object to be collected from the brush 47 of the first adsorption rotating member 2 to the second adsorption rotating member 3, but does not regulate the end surface 44 in a contact area (adsorption region Ra) with the cleaning surface 9. Thus, the cleaning width of the brush 47 in the longitudinal direction can be secured to be larger than that in Example 1 by the distance 53. In other words, the longitudinal position of the first sealing member 31R and the longitudinal position of the end surface 44 of the brush 47 can be avoided from overlapping in the transfer area, and hence the cleaning width can be increased while avoiding upsizing of a product in the width direction.

FIG. 7 is a partial perspective view of the vicinity of the regulating guide 50 in Example 2. A slope 54 is formed on the side surface 51 of the regulating guide 50 such that a force for gradually pushing a brush hair at a longitudinal end of the brush 47 oriented to the transfer area to the longitudinal inner side acts on the brush 47. Because the slope 54 is formed, the brush hair at the longitudinal end of the brush 47 can be gently and gradually changed to a predetermined regulated state toward the transfer area after an object to be collected C has been adsorbed at the cleaning surface 9, and hence load on the end surface 44 of the brush 47 can be reduced.

Example 3

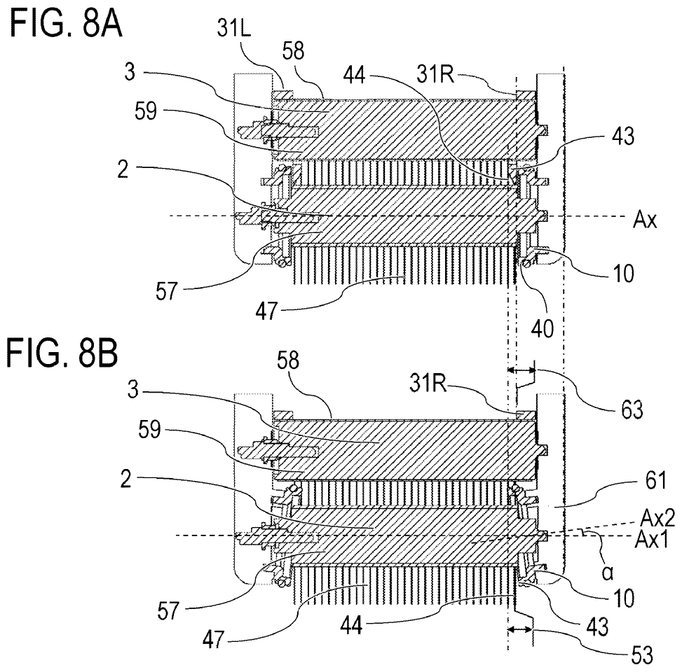

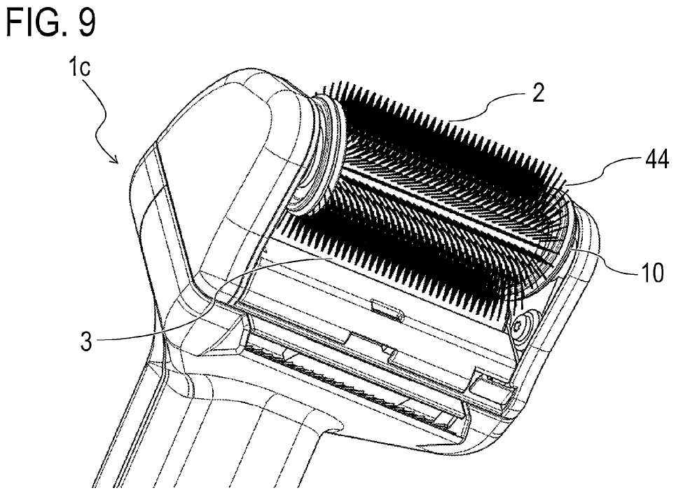

Referring to FIGS. 8A and 8B and FIG. 9, a cleaning device 1c according to Example 3 of the present disclosure is described. Configurations in Example 3 different from Examples 1 and 2 are mainly described. Configurations in Example 3 common to Examples 1 and 2 are denoted by the same reference symbols, and repetitive descriptions are omitted. Matters that are not particularly described in Example 3 are the same as in Examples 1 and 2.

As compared with Example 2, the cleaning device 1c according to Example 3 is configured such that the regulation of the longitudinal end surface 44 of the brush 47 of the first adsorption rotating member 2 is gentler and accordingly the regulation load on the end surface 44 of the brush 47 can be further reduced.

FIG. 8A is a view for a comparative configuration in Example 3, which is similar to FIG. 6B in Example 2. FIG. 8B is a schematic simple view in a top surface direction for describing a positional relation between the first sealing member 31R, the second sealing member 31L and a longitudinal end surface 44 of the brush 47 of the first adsorption rotating member 2 in Example 3.

In the cleaning device 1b in Example 2, as illustrated in FIG. 8A, the first adsorption rotating member 2 and the wheel 10 are disposed coaxially (each rotatably around rotational axis Ax). On the other hand, in the cleaning device 1c according to the present example, as illustrated in FIG. 8B, the wheel 10 is configured such that its rotational axis Ax2 has an angle α with respect to a rotational axis Ax1 of the first adsorption rotating member 2. More specifically, the wheel 10 is pivotally supported to the frame 61 of the A frame body 6 so as to be rotatable (freely rotatable), and is disposed such that its rotational axis Ax2 is inclined with an angle α of about 5 degrees with respect to the rotational axis Ax1 of the first adsorption rotating member 2.

The side surface 43 of the wheel 10 pushes the end surface 44 of the brush 47 of the first adsorption rotating member 2 to a predetermined position in the longitudinal direction so that, when a longitudinal clearance between the first sealing member 31R and the side surface 43 is denoted by 63, the clearance 63 is suppressed to the same level of the clearances in Examples 1 and 2. Furthermore, the side surface 43 of the wheel 10 regulates only the end surface 44 in the vicinity of a transfer area (collected region Rb) for an object to be collected from the brush 47 of the first adsorption rotating member 2 to the second adsorption rotating member 3, but does not regulate the end surface 44 in a contact area (adsorption region Ra) with the cleaning surface 9 in the width direction. Thus, the cleaning width of the brush 47 in the longitudinal direction can be secured to be larger than that in Example 1 by a distance 53 indicated by arrows similarly to Example 2.

FIG. 9 is a partial perspective view of the vicinity of the side surface 43 of the wheel 10 that serves as a regulating guide in Example 3. By inclining the wheel 10, the regulation toward the transfer area after an object to be collected C has been adsorbed at the cleaning surface 9 is gentler than in Example 2. Accordingly, load on the end surface 44 of the brush 47 of the first adsorption rotating member 2 can be further reduced, and the number of components can be reduced. Note that the inclined amount of the wheel 10 is minute, and hence there is no severe problem on the driven state with respect to the cleaning surface 9.

### Example 4

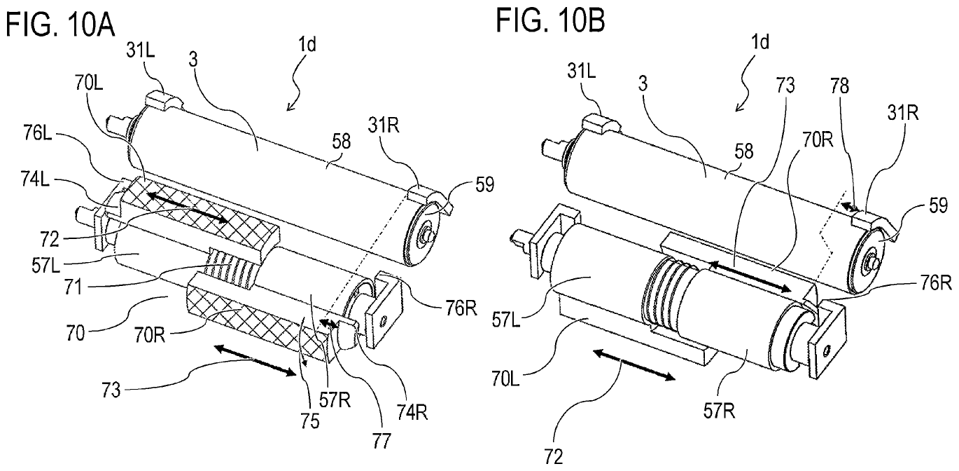

Referring to FIGS. 10A and 10B, a cleaning device 1d according to Example 4 of the present disclosure is described. Configurations in Example 4 different from Examples 1 to 3 are mainly described. Configurations in Example 4 common to Examples 1 to 3 are denoted by the same reference symbols, and repetitive descriptions are omitted. Matters that are not particularly described in Example 4 are the same as in Examples 1 to 3.

In the cleaning device 1d according to Example 4, the configuration of a first adsorption rotating member 70 is different from the configuration of the first adsorption rotating member 2 in the cleaning devices according to Examples 1 to 3. The first adsorption rotating member 70 in the present example is configured such that the first adsorption rotating member 70 itself is movable (displaceable) in the longitudinal direction. This configuration can reduce the product width and maximize the cleaning width.

FIG. 10A and FIG. 10B are schematic perspective views illustrating only configurations in the vicinity of the first adsorption rotating member 70 and a second adsorption rotating member 3 in the cleaning device 1d in Example 4. The first adsorption rotating member 70 is divided into 70L and 70R at the center, and a compression spring 71 is provided at the center such that the first adsorption rotating member 70 is pressed to outer directions of arrows 72 and 73.

More specifically, the first adsorption rotating member 70 includes, as first rotating members, a right side rotating member 57R disposed on one side in the longitudinal direction and a left side rotating member 57L disposed on the other side. The right side rotating member 57R and the left side rotating member 57L are coaxially disposed side by side in the longitudinal direction, and are supported by an A frame body 6 so as to be independently displaceable in the longitudinal direction. A compression spring 71 is disposed between the right side rotating member 57R and the left side rotating member 57L so as to generate a biasing force that acts to separate the right side rotating member 57R and the left side rotating member 57L in the longitudinal direction.

Furthermore, the first adsorption rotating member 70 includes, as first adsorption portions, a right side adsorption surface 70R that is a right side adsorption portion provided to the right side rotating member 57R and a left side adsorption surface 70L that is a left side adsorption portion provided to the left side rotating member 57L. The right side adsorption surface 70R is provided to the right side rotating member 57R so as to rotationally move around a rotational axis of the right side rotating member 57R along with the rotation of the right side rotating member 57R. Similarly, the left side adsorption surface 70L is provided to the left side rotating member 57L so as to rotationally move around a rotational axis of the left side rotating member 57L along with the rotation of the left side rotating member 57L.

The right side adsorption surface 70R and the left side adsorption surface 70L each include, in one rotation around the rotational axis, an adsorption phase to be opposed to the cleaning surface 9 and a collected phase opposed to the second adsorption portion 58. The right side adsorption surface 70R and the left side adsorption surface 70L are disposed in different phases in the circumferential direction around the rotational axis, and hence, during the rotation of the right side adsorption surface 70R and the left side rotating member 57L, a timing at which the right side adsorption surface 70R is located in the adsorption phase and a timing at which the left side adsorption surface 70L is located in the adsorption phase are different from each other. Similarly, during the rotation of the right side adsorption surface 70R and the left side rotating member 57L, a timing at which the right side adsorption surface 70R is located in the collected phase and a timing at which the left side adsorption surface 70L is located in the collected phase are different from each other.

Furthermore, the right side adsorption surface 70R and the left side adsorption surface 70L are configured to overlap each other at a center portion of the first adsorption rotating member 70 in the longitudinal direction when viewed in the circumferential direction around the rotational axis.

Furthermore, cam shapes 74R and 74L are provided to end surfaces of the right side rotating member 57R and the left side rotating member 57L, respectively. When arriving at positions corresponding to cam surfaces 76R and 76L provided to side surfaces of the A frame body 6, the cam shapes 74R and 74L slide with respect to the cam surfaces 76R and 76L along with the shapes of the cam surfaces 76R and 76L in conjunction with the rotation of the first adsorption rotating member 70 in an arrow 75. In this manner, forces in the longitudinal direction indicated by an arrow 73 and an arrow 72 act on the right side rotating member 57R and the left side rotating member 57L, respectively, so that the right side rotating member 57R and the left side rotating member 57L move in the longitudinal direction.

Specifically, the right side rotating member 57R has the cam shape 74R as a right side acted portion on its end surface on the outer side in the longitudinal direction. The cam shape 74R is provided to the right side rotating member 57R so as to rotationally move around the rotational axis along with the rotation of the right side rotating member 57R. Similarly, the left side rotating member 57L has the cam shape 74L as a left side acted portion on its end surface on the outer side in the longitudinal direction. The cam shape 74L is provided to the left side rotating member 57L so as to rotationally move around the rotational axis along with the rotation of the left side rotating member 57L.

Furthermore, the A frame body 6 has the cam surface 76R as a right side acting portion of the regulating member. The cam surface 76R is provided to the A frame body 6 so as to contact the cam shape 74R of the right side rotating member 57R while the right side adsorption surface 70R is in the collected phase. Similarly, the A frame body 6 has the cam surface 76L as a left side acting portion of the regulating member. The cam surface 76L is provided to the A frame body 6 so as to contact the cam shape 74L of the left side rotating member 57L while the left side adsorption surface 70L is in the collected phase.

The cam surface 76R and the cam shape 74R can contact each other such that a force for displacing the right side rotating member 57R from one side (right side) in the longitudinal direction to the other side (left side) against a biasing force of the compression spring 71 acts on the right side rotating member 57R while allowing the rotation of the right side rotating member 57R. The cam surface 76L and the cam shape 74L can contact each other such that a force for displacing the left side rotating member 57L from the other side (left side) in the longitudinal direction to one side (right side) against the biasing force of the compression spring 71 acts on the left side rotating member 57L while allowing the rotation of the left side rotating member 57L.

Owing to the action of the cam surface 76R, while the right side adsorption surface 70R is in the collected phase, the longitudinal position of the right side rotating member 57R is regulated such that the position of an end of the right side adsorption surface 70R on one side in the longitudinal direction is located on the inner side of a contact region between the first sealing member 31R and the second adsorption portion 58 in the longitudinal direction. Owing to the action of the cam surface 76L, while the left side adsorption surface 70L is in the collected phase, the longitudinal position of the left side rotating member 57L is regulated such that the position of an end of the left side adsorption surface 70L on the other side in the longitudinal direction is located on the inner side of a contact region between the second sealing member 31L and the second adsorption portion 58 in the longitudinal direction.

FIG. 10A is a view when the right side adsorption surface 70R (hatched portion) of the first adsorption rotating member 70 is opposed to the cleaning surface 9 (not shown) located on the front side in the drawing (is located in adsorption phase). In this case, a longitudinal gap between the right side rotating member 57R and the left side rotating member 57L is wide such that a clearance of a distance 77 is provided on the outer side in the longitudinal direction between the longitudinal end surface of the right side rotating member 57R and the first sealing member 31R. On the other hand, FIG. 10B is a view when the right side adsorption surface R of the first adsorption rotating member 70 is located at a position opposed to the second adsorption rotating member 3 (located in collected phase). In this case, a longitudinal gap between the right side rotating member 57R and the left side rotating member 57L is narrow such that a clearance of a distance 78 is provided on the inner side in the longitudinal direction between longitudinal end surfaces (longitudinal ends of right side adsorption surface 70R and left side adsorption surface 70L) of the right side rotating member 57R and the left side rotating member 57L, the first sealing member 31R and the second sealing member 31L. In this manner, the right side adsorption surface 70R and the left side adsorption surface 70L can shift to the inner side at a transfer portion while increasing the width of a cleaning surface, thereby obtaining the same effects as in Examples 2 and 3.

Furthermore, the first adsorption rotating member 70 is configured such that the phases of the right side adsorption surface 70R and the left side adsorption surface 70L shift from each other and the right side adsorption surface 70R and the left side adsorption surface 70L overlap at the center portion, thereby preventing cleaning failure at the center portion.

Note that the adsorption surface (hatched portion) of the first adsorption rotating member 70 for an object to be collected C may have a brush shape or a rigid body, but the present example shows an example where the adsorption surface is a rigid body. In the case of a rigid body, the brush end cannot be deformed unlike Examples 2 and 3, and hence the present example is an example where the first adsorption rotating member itself can shift. Although not described in detail, the cam means described above is not necessarily required to be disposed at the end surface of the first adsorption rotating member 70, and may be disposed at the middle as long as the same effects are obtained. In such a case, the end surface portion is released, and hence the first adsorption rotating member 70 can be supported like a cantilever, and as a result, when there is a wall on the cleaning surface 9, an effect that a corner of the wall can be easily cleaned is obtained.

### Example 5

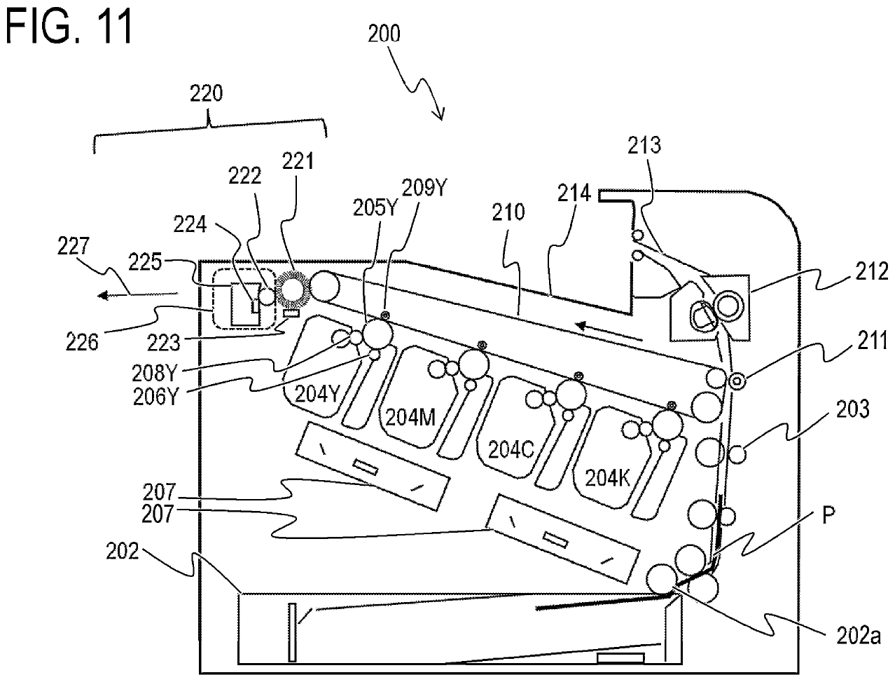

Referring to FIG. 11, a cleaning device according to Example 5 of the present disclosure is described. Configurations in Example 5 different from Examples 1 to 4 are mainly described. Configurations in Example 5 common to Examples 1 to 4 are denoted by the same reference symbols, and repetitive descriptions are omitted. Matters that are not particularly described in Example 5 are the same as in Examples 1 to 4.

The present example is an example in which a cleaning device having the same configuration as the cleaning device in any of Examples 1 to 4 is applied, as a cleaning unit, to toner cleaning in an electrophotographic image forming apparatus. The size of the cleaning unit in the longitudinal direction can be reduced, and hence the size of the electrophotographic image forming apparatus can be reduced and accordingly there is an effect on the improvement on detachability of a cleaning device unit.

FIG. 11 is a transverse cross-sectional view illustrating an overall configuration of a full-color laser beam printer 200 (hereinafter referred to as printer 200) as an image forming apparatus according to an example of the present disclosure.

First, the basic configuration and operation of the printer 200 are described. At a lower part of the printer 200, a paper cassette 202 is housed so as to be drawable. The paper cassette 202 loads and houses sheets P (recording materials) therein. The sheets P are separated by a separation roller 202a one by one, and are fed by a registration roller pair 203 at a conveying speed of 300 mm/sec.

In the printer 200, image forming portions (image forming stations) 204Y, 204M, 204C, and 204K corresponding to yellow, magenta, cyan, and black, respectively, are provided side by side. The image forming portion 204Y includes a photosensitive drum 205Y as an image bearing member and a charging member 206Y for uniformly charging the surface of the photosensitive drum 205Y. Furthermore, a scanner unit 207 for applying a laser beam on the basis of image information to form an electrostatic latent image on the photosensitive drum 205Y is provided under the image forming portion 204Y. The scanner unit 207 forms an electrostatic latent image on the photosensitive drum 205Y, and toner is caused to adhere to the electrostatic latent image by a developing member 208Y so that the electrostatic latent image becomes a toner image. Note that a reversal development system in which toner is charged to negative polarity is used.

The toner image is transferred to an intermediate transfer belt 210 as an intermediate transfer member at a primary transfer portion 209Y. The intermediate transfer belt 210 is rotationally driven in an arrow direction at 300 mm/sec equal to the conveying speed of the recording material, and superimposes toner images through similar steps in the image forming portion 204M, the image forming portion 204C, and the image forming portion 204K. The superimposed toner images are transferred onto the sheet P at a secondary transfer portion 211, and passes through an image heating device 212 to become a permanently fixed image. The sheet P passes through a discharge and conveying portion 213, and is discharged and loaded on a loading portion 214. Toner that has not been transferred to the sheet P but remained on the intermediate transfer belt 210 is collected by an intermediate transfer belt cleaning device 220 that is one form of a cleaning device disposed in contact with the intermediate transfer belt 210.

The intermediate transfer belt cleaning device 220 includes a first adsorption rotating member 221, a second adsorption rotating member 222, a rubbing member 223, and a blade 224. In the second adsorption rotating member 222, an edge sealing (not shown) is disposed to prevent leakage of toner from the waste toner container 225.

Note that a waste toner container assembly 226 from the second adsorption rotating member 222 to the waste toner container 225 can be detached from the printer 200 in a direction of an arrow 227.

The first adsorption rotating member 221 is formed by a brush, and hence brush ends may vary to the outer side in the width direction in a transfer region from the first adsorption rotating member 221 to the second adsorption rotating member 222 similarly to the other examples. Thus, similarly to the other examples, the position of a brush end in the longitudinal width direction is regulated by an end regulating member (regulating portion) (not shown), such that, as compared to the case where the regulating member is not provided, the clearance from the edge sealing (not shown) can be minimized. Thus, the second adsorption rotating member 222 can be downsized in the longitudinal direction similarly to the other examples, and the width of the waste toner container assembly 226 can be reduced in the longitudinal direction as compared with the case where no regulating member is provided. In this manner, in the case of detaching the waste toner container assembly 226 from the printer 200 in the direction of the arrow 227, the size of an opening of a main body frame (not shown) can be reduced. Furthermore, the retreat of components inside the printer on a detachment route can be minimized, which is a significant effect on the downsizing of printers in recent years while suppressing the reduction in frame strength.

Note that, in the present example, toner that is an object to be collected is a negatively charged material, and hence a brush material of the first adsorption rotating member 221 and a material of the second adsorption rotating member 222 are nylon. A material of the rubbing member 223 is PFA on the negative side in charging, so that positive charging of the first adsorption rotating member 221 is stabilized. The second adsorption rotating member 222 actively rubs the blade 224 made of polyurethane, which is on the negative side in the triboelectric series, thereby positively charging the second adsorption rotating member 222 more powerfully such that waste toner can be transferred.

As described above, the cleaning devices in Examples 1 to 4 are applicable to toner cleaning in an electrophotographic image forming apparatus.

Although not described in detail herein, in the printer 200, due to paper dust of a sheet P (paper) itself or due to residual of paper dust in a conveying path during conveyance, image failure may occur. Thus, it should be understood that, by applying the cleaning device of the present disclosure to such a part, paper dust can be corrected to suppress image failure. Furthermore, the size in the width direction is small, and hence the detachability is satisfactory and the printer 200 can be downsized.

The above-mentioned configurations in the examples can be used in any possible combinations.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-187027, filed on Oct. 31, 2023, which is hereby incorporated by reference herein in its entirety.

What is claimed is:

1. A cleaning device, comprising:
a first rotating member including a first adsorption portion configured to electrostatically adsorb an object to be collected from a surface to be cleaned;
a second rotating member including a second adsorption portion configured to electrostatically adsorb the object to be collected from the first adsorption portion;
a removable unit configured to remove the object to be collected that has been adsorbed to the second adsorption portion;
a housing container configured to house the object to be collected that has been removed by the removable unit;
a sealing member disposed between an end portion of the second adsorption portion in a longitudinal direction along a rotational axis of the second rotating member and the housing container; and
a regulating member configured to regulate a position of an end surface of the first adsorption portion to be inside of a contact region between the sealing member and the second adsorption portion in the longitudinal direction.

2. The cleaning device according to claim 1,
wherein the first adsorption portion comprises:
an adsorption region to be opposed to the surface to be cleaned; and
a collected region opposed to the second adsorption portion, and
wherein the regulating member regulates at least a position of the end surface in the collected region of the first adsorption portion to an inner side of the contact region in the longitudinal direction.

3. The cleaning device according to claim 2, wherein a position of the end surface in the adsorption region of the first adsorption portion is on an outer side of the position of the end surface in the collected region of the first adsorption portion in the longitudinal direction.

4. The cleaning device according to claim 1, further comprising disc members disposed on both sides of the first rotating member in the longitudinal direction so as to be rotatable,
wherein the regulating member is a contact portion provided to the disc member so as to contact the end surface in the longitudinal direction.

5. The cleaning device according to claim 4, wherein a rotational axis of the disc member is coaxial with a rotational axis of the first rotating member.

6. The cleaning device according to claim 4, wherein a direction in which a rotational axis of the disc member extends has an angle with respect to a direction in which a rotational axis of the first rotating member extends.

7. The cleaning device according to claim 4, wherein the disc member is a wheel, and the wheel contacts the surface to be cleaned so as to keep a constant opposing distance between the first adsorption portion and the surface to be cleaned, and moves the cleaning device with respect to the surface to be cleaned.

8. The cleaning device according to claim 1, further comprising a frame body for supporting the first rotating member, the second rotating member, the removable unit, and the housing container,
wherein the regulating member comprises a contact portion provided to the frame body so as to contact the end surface in the longitudinal direction.

9. The cleaning device according to claim 1,
wherein the first adsorption portion is provided to the first rotating member so as to rotationally move around a rotational axis of the first rotating member along with rotation of the first rotating member,
wherein the first adsorption portion includes, in one rotation around the rotational axis, an adsorption phase to be opposed to the surface to be cleaned and a collected phase opposed to the second adsorption portion,
wherein the first rotating member is provided to be displaceable in the longitudinal direction, and
wherein the regulating member regulates, at least while the first adsorption portion is in the collected phase, a position of the first rotating member in the longitudinal direction such that the position of the end surface is located on an inner side of the contact region in the longitudinal direction.

10. The cleaning device according to claim 9,
wherein the first rotating member comprises:
a right side rotating member disposed on one side in the longitudinal direction;
a left side rotating member disposed on another side in the longitudinal direction; and
a spring for generating biasing force that acts to separate the right side rotating member and the left side rotating member in the longitudinal direction,
wherein the first adsorption portion comprises:
a right side adsorption portion provided to the right side rotating member; and
a left side adsorption portion provided to the left side rotating member, and
wherein the right side adsorption portion and the left side adsorption portion are disposed in different phases around the rotational axis, and are configured to overlap each other at a center portion in the longitudinal direction in a case of being viewed in a circumferential direction around the rotational axis.

11. The cleaning device according to claim 10,
wherein the sealing member comprises:
a first sealing member disposed between one end of the second adsorption portion in the longitudinal direction and the housing container; and
a second sealing member disposed between another end of the second adsorption portion in the longitudinal direction and the housing container,
wherein the regulating member regulates, at least while the right side adsorption portion is in the collected phase, a position of an end surface of the right side adsorption portion on one side in the longitudinal direction to another side in the longitudinal direction with respect to a contact region between the first sealing member and the second adsorption portion, and
wherein the regulating member regulates, at least while the left side adsorption portion is in the collected phase, a position of an end surface of the left adsorption portion on the another side to the one side with respect to a contact region between the second sealing member and the second adsorption portion.

12. The cleaning device according to claim 11, further comprising a frame body configured to support the cleaning device, the first rotating member, the second rotating member, the removable unit, and the housing container,
wherein the right side rotating member comprises a right side acted portion provided to the right side rotating member so as to rotationally move around the rotational axis along with rotation of the right side rotating member,
wherein the left side rotating member comprises a left side acted portion provided to the left rotating member so as to rotationally move around the rotational axis along with rotation of the left rotating member,
wherein the regulating member comprises:
a right side acting portion provided to the frame body so as to contact the right side acted portion while the right side adsorption portion is in the collected phase; and
a left side acting portion provided to the frame body so as to contact the left side acted portion while the left side adsorption portion is in the collected phase,
wherein the right side acting portion and the right side acted portion are configured to contact each other such that a force for displacing the right side rotating member from the one side to the another side against a biasing force of the spring acts on the right side rotating member while allowing rotation of the right side rotating member, and
wherein the left side acting portion and the left side acted portion are configured to contact each other such that a force for displacing the left side rotating member from the another side to the one side against the biasing force of the spring acts on the left side rotating member while allowing rotation of the left side rotating member.

13. The cleaning device according to claim 1, wherein the first adsorption portion is a brush.

14. The cleaning device according to claim 1, wherein the first rotating member and the second rotating member are disposed in parallel to each other.

15. The cleaning device according to claim 1,
wherein the sealing member comprises:
a first sealing member disposed between one end of the second adsorption portion in the longitudinal direction and the housing container; and
a second sealing member disposed between another end of the second adsorption portion in the longitudinal direction and the housing container,
wherein the removable unit comprises:
a blade member that extends in the longitudinal direction between an end of the first sealing member on a downstream side of a rotating direction of the second rotating member and an end of the second sealing member on a downstream side of the rotating direction of the second rotating member, the blade member being configured to contact the second adsorption portion so as to form a contact region with the second adsorption portion; and
a sheet member that extends in the longitudinal direction between an end of the first sealing member on an upstream side of the rotating direction of the second rotating member and an end of the second sealing member on an upstream side of the rotating direction of the second rotating member, the sheet member being configured to contact the second adsorption portion so as to form a contact region with the second adsorption portion, and
wherein a region of the second adsorption portion that is surrounded by the first sealing member, the second sealing member, the blade member, and the sheet member is exposed to inside of the housing container.

16. The cleaning device according to claim 1, wherein the cleaning device is provided to an image forming apparatus in which paper dust or toner present in the image forming apparatus is the object to be collected.

17. The cleaning device according to claim 1, wherein the surface to be cleaned comprises a surface of an intermediate transfer member included in an image forming apparatus.
